(19) United States
(12) Patent Application Publication
(10) Pub. No.: US 2005/0237893 A1
(43) Pub. Date: Oct. 27, 2005

(54) Optical disk and optical disk recording device

(75) Inventor: Yoshikazu Gotoh, Hirakata-shi (JP)

Correspondence Address: STEPTOE & JOHNSON LLP, 1330 CONNECTICUT AVENUE, N.W., WASHINGTON, DC, 20036, US

(73) Assignee: Matsushita Elec. Ind. Co., Ltd., Kadoma-shi (JP)

(21) Appl. No.: 11/085,147

(22) Filed: Mar. 22, 2005

(30) Foreign Application Priority Data
Apr. 23, 2004 (JP) 2004-127470

(51) Int. Cl. G11B 7/007

(52) U.S. Cl. 369/94; 369/273; 369/53.21

(57) ABSTRACT

An optical disk configured as a laminated disk including a 0.6 mm thick transparent substrate and a protective substrate that are bonded with an adhesive element, wherein a data recording layer and a reflection layer are layered on the transparent substrate, a thermal layer and a transparent protective layer are layered on the protective layer, and the inner circumference area has a disk clamp area surface that protrudes from the surface, and the disk thickness of the disk clamp area surface is 1.4 mm and the thickness of the other area is 1.2 mm. Also provided is an optical disk recording device including a turntable, and an optical pickup provided with optical elements including an objective lens suitable for a 0.6 mm substrate, wherein a protruding section of the optical disk is set on the turntable, and the laser beam from the objective lens is focused on the thermal layer to record visual information.

### BACKGROUND OF THE INVENTION

1. Field of the Invention

The present invention relates to an optical disk and an optical disk recording device for creating visual information, such as text and images, on the surface of the optical disk using the laser beam of the optical disk recording device, and more particularly to an optical disk and optical disk recording device that can be suitably applied to a slim type optical disk recording device.

2. Description of the Related Art

A conventional optical disk for creating visual information on the surface of the optical disk using a laser beam is comprised a data processing layer, a reflection layer, a thermal layer and a transparent protective layer, which are layered on a 1.2 mm substrate, so as to conform to CD standards for optical disks. The thermal layer is comprised of a thermal material, and if a laser beam with a predetermined or more power is irradiated, the color of the irradiated area changes. This optical disk is turned over and set on the turntable of the optical disk recording device, and is rotated in a status where the thermal layer faces the optical pickup, the laser beam of the optical pickup is focused on the thermal layer, then the laser beam, of which power is modulated based on the visual information to be created, is irradiated onto the thermal layer to create the visual information (e.g. see Japanese Patent Application Laid-Open No. 2003-203348 (p. 19, FIG. 26 and FIG. 27)).

### SUMMARY OF THE INVENTION

With a conventional configuration, however, an optical pickup for a CD disk, which is for a 1.2 mm substrate, is used for creating visual information, and the laser beam of the optical pickup focuses on the thermal layer in the status where the thermal layer faces the optical pickup, so this focal point position is about 0.8 mm different from the focal point position of an ordinary optical pickup where the recording layer side is facing the optical pickup. Therefore, the movable range of the objective lens actuator in the focus direction in the optical pickup must be taken to be wider. As a countermeasure for the case when the movable range of the objective lens actuator in the focus direction in the optical pickup is insufficient, inserting an adapter with a predetermined thickness between the optical disk and the turntable, or disposing a drive mechanism for separating the optical pickup from the turntable for a predetermined amount, has been considered.

However in the case of the above mentioned configuration in which the focal point position of the objective lens is considerably different, 0.8 mm or larger space margin in the height direction is required compared with an ordinary optical disk recording device, which is difficult to be implemented for a slim type optical disk recording device of which the thickness is 12.7 mm or less, since this space margin cannot be taken. In the case of a configuration in which an adapter with a predetermined thickness is inserted between the optical disk and turntable, the space of the disk clamp differs considerably, so that a specified clamp force cannot be secured for a magnet clamp system, and it is also difficult to apply a mechanical clamp system for holding the central hole of the optical disk by clamp claws. Also there is an operability problem, since the user sets the adapter at every usage, and there is another problem that the forgoing configuration cannot be used for a slot loading type device where the optical disk is directly inserted through an insertion slot of the optical disk recording device. In such configuration where a drive mechanism is disposed for separating the optical pickup from the turntable for only a predetermined amount, the device configuration becomes complicated and the device becomes expensive.

To solve the above problems of a conventional configuration, it is an object of the present invention to provide an optical disk and an optical disk device that can be applied to a slim type optical disk recording device of which the device height is 12.7 mm or less, and can create such visual information as text and images on the surface of the optical disk using the laser beam of the optical disk recording device.

To solve the conventional problems, the optical disk of the present invention is an optical disk comprising a transparent substrate disposed on one surface of the disk, a data recording layer for recording data inside of the transparent substrate by a laser beam irradiated through the transparent substrate, and a visual information recording layer disposed on a disk surface opposite to the transparent substrate, for creating visual information by irradiating a laser beam. The optical disk further comprises a protruding section located in an inner circumference area including a disk clamp area surface at the visual information recording layer side, the protruding section protruding from the surface at the visual information recording layer so that an optical distance from the protruding end face to the visual information recording layer approximates to or equal to the optical distance from the transparent substrate outer surface to the data recording layer.

It is preferable that the thickness of the disk at the area where the visual information recording layer is disposed is 1.2 mm and the thickness of the disk at the area where the protruding section is disposed is 1.4 mm or less. Also an FG pattern for synchronizing disk motor rotation that can be optically detected and a reference pattern for disk position detection are created outside the disk clamp area and inside the area of the visual information recording layer. Also the protruding section has a configuration where a circular seal is glued onto the optical disk with a 1.2 mm disk thickness, and the FG pattern and the reference pattern are created on the circular seal.

The optical disk recording device of the present invention is an optical disk recording device for recording visual information on the optical disk, comprising a disk motor having a turntable, a disk motor driving circuit for controlling the rotation of the disk motor, an optical pickup comprising optical elements including an objective lens for recording the visual information, a laser driving circuit for modulating the laser beam emitted from the optical pickup, and an optical pickup transporting mechanism for moving the optical pickup in the radial direction of the optical disk, wherein the optical disk is rotated in a status where the disk clamp area surface at the visual information recording layer of the optical disk is set on the turntable, and the laser beam modulated based on the visual information data of the optical pickup is focused on the visual information recording layer and irradiated, while moving the optical pickup in the radial direction, so that the visual information is created on the visual information recording layer.

It is preferable that the objective lens of the optical element is constructed so as to suit the transparent substrate that is thinner than 1.2 mm. Also an FG pattern for disk motor rotation synchronization that can be optically detected and a reference pattern for disk position detection are created on the visual information recording layer of the optical disk, a photo-coupler for detecting the FG pattern and the reference pattern is disposed in the optical disk recording device, a signal from the FG pattern detected by the photo-coupler is input to the disk motor driving circuit to control the rotation of the disk motor, and a signal from the reference pattern is input to the laser driving circuit to irradiate the laser beam according to the disk rotation position. Also the optical pickup further comprises an optical element including an objective lens suitable for a 0.6 mm substrate, and this optical element is used for the optical pickup for creating the visual information. Also the optical pickup of the optical disk recording device further comprises an optical system for a CD disk and an optical system for a DVD disk, and the optical system for a DVD disk is used for the optical pickup for creating the visual information.

According to the optical disk of the present invention, in the shape conforming to the optical disk standards for CD and DVD, the optical distance between the position of the thermal layer in a status where the optical disk is set on the turntable for recording the visual information and the position of the data recording layer in a status where the optical disk is set on the turntable for recording the data information, can be made closer as compared with conventional optical disks. Hence, the moving amount of the objective lens of the optical pickup installed on the optical disk recording device for recording the data information and the visual information on the optical disk can be decreased.

Also according to the optical disk recording device for recording the visual information on the optical disk according to the present invention, the optical pickup that can be used comprises optical elements including an objective lens suitable for a transparent substrate that is thinner than 1.2 mm for recording the visual information. Hence, as compared with the case of using a conventional optical system for a 1.2 mm substrate, the position of the objective lens for focusing the laser beam on the thermal layer in a status where the thermal layer is facing the optical pickup approaches the position of the objective lens for focusing the laser beam on the data recording layer in a status where the recording layer side is facing the optical pickup. As a result, it is unnecessary to add such additional functions as to record visual information to an ordinary optical disk recording device. Therefore, regardless the difference of the loading mechanism and the disk clamp system, the optical pickup of the present invention can be applied to an optical disk recording device mounted with the optical pickup according to the present invention, especially to a slim type optical disk recording device of which device height is 12.7 mm or less.

### BRIEF DESCRIPTION OF THE DRAWINGS

FIG. 1 is a cross-sectional view depicting a part of an optical disk according to the first embodiment of the present invention;

FIG. 2 is a plan view depicting the protruding section of an optical disk according to the first embodiment;

FIG. 3 is a perspective view depicting a circular seal to be used for the optical disk according to the first embodiment;

FIG. 4 is a cross-sectional view depicting a part of an optical disk according to a second embodiment of the present invention;

FIG. 5 is a block diagram depicting the configuration of an optical disk recording device for creating visual information on the optical disk according to the first and second embodiments of the present invention;

FIG. 6 is a diagram depicting the configuration of the optical pickup of this optical disk recording device;

FIG. 7A is a diagram depicting an optical path of the optical pickup when data is recorded to/regenerated from the optical disk according to the first embodiment;

FIG. 7B is a diagram depicting an optical path of the optical pickup when data is recorded to/regenerated from the optical disk according to the second embodiment;

FIG. 8 is a flow chart depicting the operation of the optical disk recording device;

FIG. 9A and FIG. 9B are diagrams depicting the positional relationship of the objective lens in the case of recording the visual information on the optical disk of the present invention respectively.

### DESCRIPTION OF THE PREFERRED EMBODIMENTS

Embodiments of the optical disk and the optical disk recording device of the present invention will now be described with reference to the drawings.

### Embodiment 1

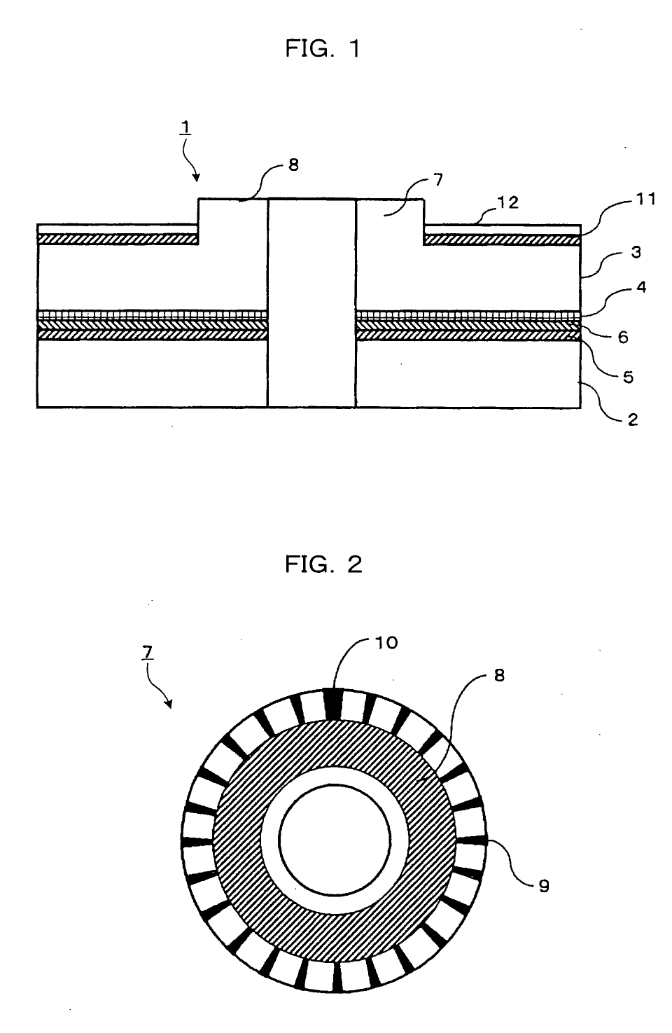

FIG. 1 is a cross-sectional view depicting a part of the optical disk according to the first embodiment. FIG. 2 is a plan view depicting the protruding section of the optical disk of this embodiment.

In FIG. 1, the optical disk 1 has a laminated disk configuration where a 0.6 mm thick transparent substrate 2 made of polycarbonate, for example, and a 0.6 mm thick protective substrate 3, are bonded using an adhesive element 4 such as UV hardening resin. This disk configuration is the same as the configuration of a DVD disk. A guide groove (not illustrated) is created on one side of the transparent substrate 2, and the data recording layer 5 and reflection layer 6 are layered on the guide groove surface. The inner circumference section of the protective substrate 3 has a protruding section 7, which protrudes from the surface, and the surface of the protruding section 7 includes the disk clamp area surface 8. The protruding section 7 is integrated with the protective substrate 3 by injection molding. An FG pattern 9 for synchronizing the disk motor rotation that can be optically detected and a reference pattern 10 for disk position detection are created outside the disk clamp area surface 8 of the protruding section 7 (see FIG. 2).

As FIG. 2 shows, the FG pattern 9 has a radial pattern with a predetermined width, and the reference pattern 10 is comprised of a pattern having a wider width than the width of the FG pattern 9. The FG pattern 9 and the reference pattern 10 have bump patterns, and the bump transfer pattern is created in a die, and is transferred to the protruding section 7 when injection molding is performed. The FG pattern 9 and the reference pattern 10 are detected by the later mentioned photo-coupler, so that the patterns are not limited to a bump shape, but may be created by screen printing.

As FIG. 1 shows, the thermal layer 11 to be the visual information recording layer and the transparent protective layer 12 are layered on the surface of the protective substrate 3. The thermal layer 11 is made of a thermal material where if a laser beam with a predetermined power or more is irradiated, the color of that irradiated area changes. An example of a thermal material suitable for the present invention is a micro-capsule pigment, that is an encapsulated pigment. If a laser beam with a predetermined power or more is irradiated onto the micro-capsule pigment, the micro-capsules are dissolved, and color is generated. The protective layer 12 is made of a hard coat material for surface protection used for optical disks, and the thickness of this protective layer 12 is 2-10 microns.

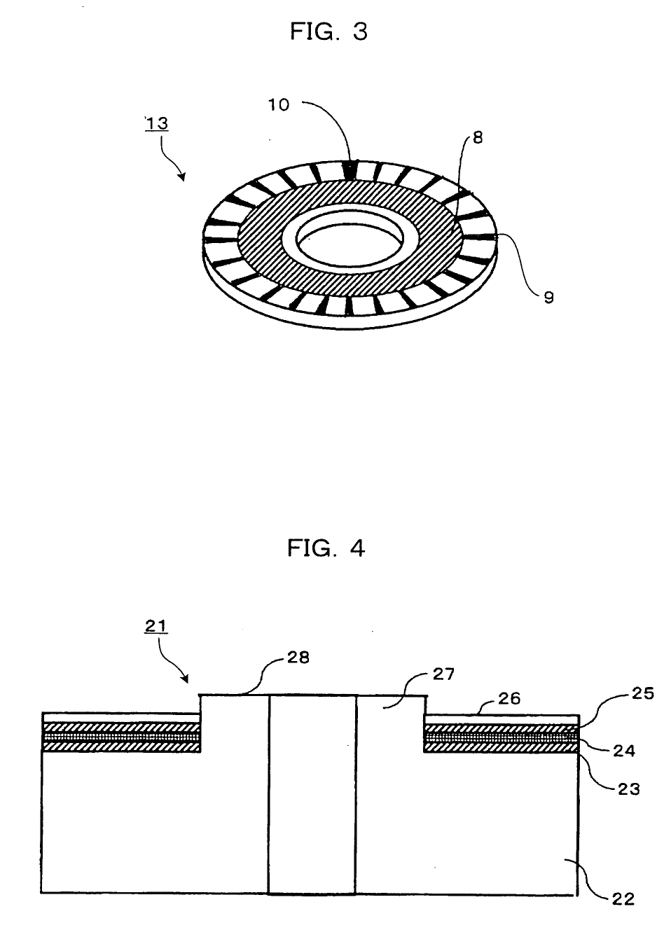

For the thickness of the optical disk 1, the disk thickness of the disk clamp area surface 8 is 1.4 mm, and the disk thickness of the other area is 1.2 mm, and these numeric values are values that conform to DVD disk standards. In the present embodiment, a protruding section 7 is created by integrated molding, but for the protruding section 7, a 0.2 mm thick circular seal 13, shown in FIG. 3, may be glued onto an optical disk of which the disk thickness is 1.2 mm. The FG pattern 9 and the reference pattern 10 are printed on the circular seal 13. If the circular seal 13 is used, conventional resin substrates of CD and DVD can be used, so new equipment investment, such as for molding die, is unnecessary.

### Embodiment 2

FIG. 4 is a cross-sectional view depicting a part of the optical disk according to the second embodiment.

In FIG. 4, the optical disk 21 is a 1.2 mm thick transparent substrate 22 made of polycarbonate, for example, a guide groove (not illustrated) is created on one side of the transparent substrate 22, and the data recording layer 23, the reflection layer 24, the thermal layer 25 and the transparent protective layer 26 are layered on the guide groove surface. The inner circumference section of the transparent substrate 22 has a protruding section 27, which protrudes from the surface, and the surface of the protruding section 27 is a disk clamp area surface 28. For the thickness of the optical disk 1, the disk thickness of the disk clamp area surface 28 is 1.4 mm, and the disk thickness of the other area is 1.2 mm, and these numeric values are values conforming to CD disk standards. Configurations other than the above mentioned are the same as the configuration of the optical disk 1 according to the first embodiment, so a detailed description is omitted.

### Embodiment 3

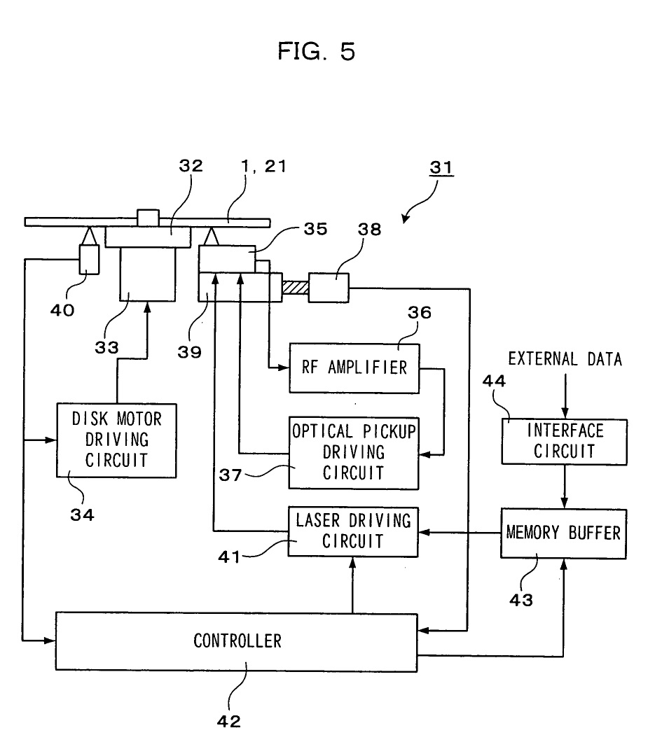

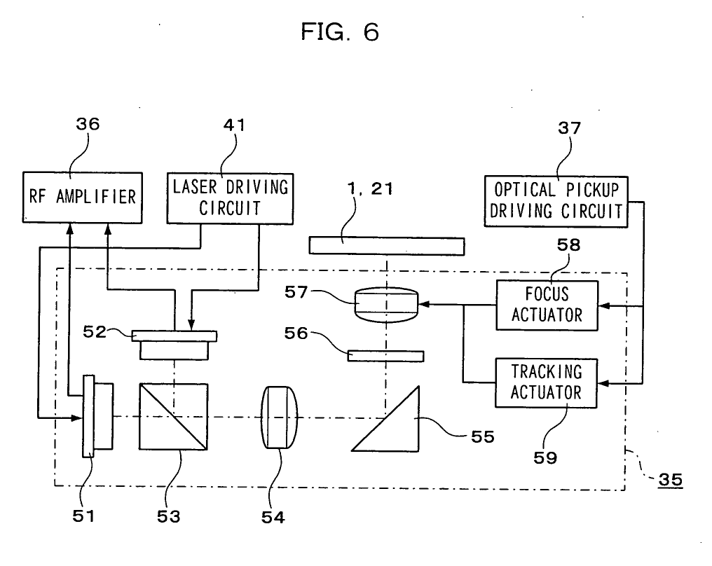

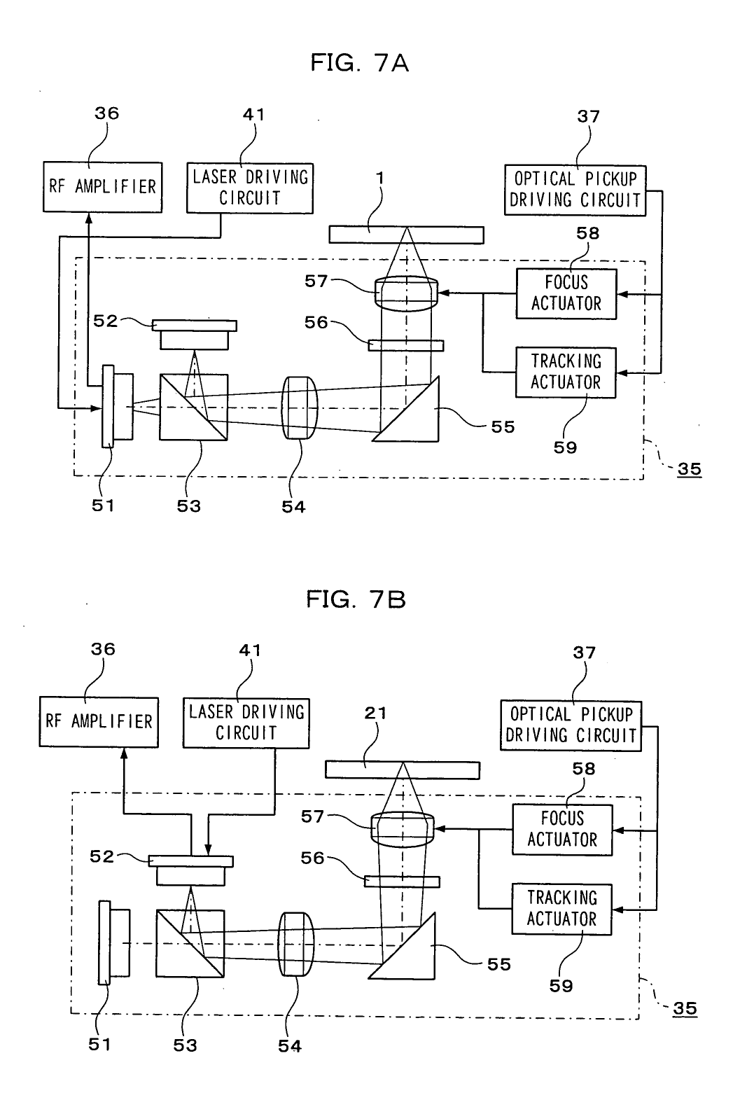

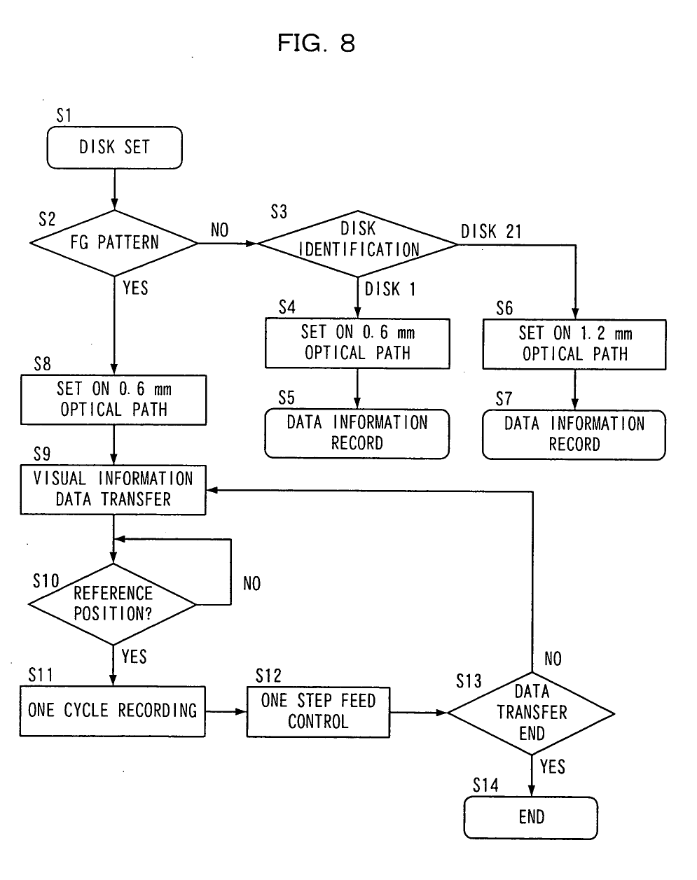

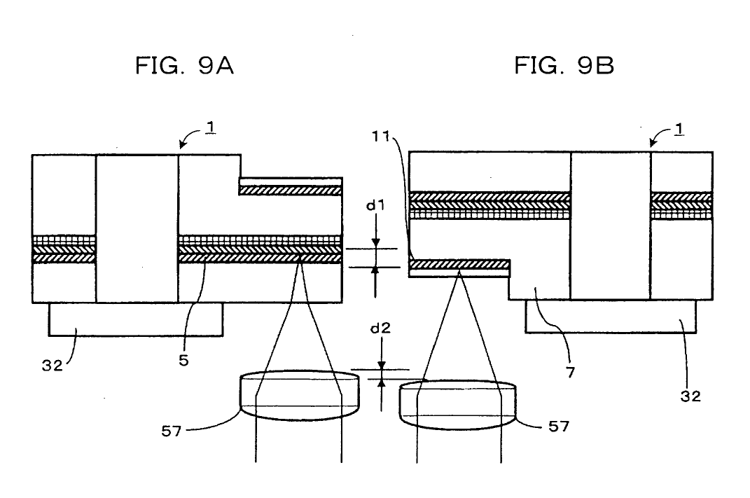

FIG. 5 is a block diagram depicting the configuration of the optical disk recording device for creating the visual information on the optical disk according to the first and second embodiments of the present invention. FIG. 6 is a diagram depicting the configuration of the optical pickup of the optical disk recording device, FIG. 7A and FIG. 7B are diagrams depicting the optical path of the optical pickup in the case when data is recorded to/regenerated from the optical disk according to the first embodiment and the optical disk according to the second embodiment, FIG. 8 is a flow chart depicting the operation of the optical disk recording device of the present invention, and FIG. 9A and FIG. 9B are diagrams depicting the positional relationship of the objective lens when the visual information is recorded to the optical disk of the present invention respectively.

As FIG. 5 shows, the optical disk recording device 31 is comprised of a disk motor 33 further comprising a turntable 32, a disk motor driving circuit 34 for controlling the rotation of the disk motor 33, an optical pickup 35 for recording the visual information on an optical disk 1 or optical disk 21 (hereafter called optical disk 1, 21), an RF amplifier 36, an optical pickup driving circuit 37, an optical pickup transporting mechanism 39 which is connected to the stepping motor 38 for moving the optical pickup 35 in the radial direction of the optical disk 1, 21, a photo-coupler 40 for detecting the FG pattern of the optical disk 1, 21 and the reference pattern 10, a laser driving circuit 41 for modulating the laser beam emitted from the optical pickup 35, a controller 42, a memory buffer 43 and an interface circuit 44.

In this case, the optical pickup 35 is an optical pickup for CD/DVD recording which can record information on both optical disks of the CD disk with a 1.2 mm substrate and the DVD disk with a 0.6 mm substrate, which will be described with reference to FIG. 6. The optical pickup 35 is comprised of a laser detector integrated module 51 further comprising a semiconductor laser with a 635 nm wavelength, a laser detector integrated module 52 further comprising a semiconductor laser with a 780 nm oscillation wavelength, a polarization beam splitter 53, a condensing lens 54, a mirror 55, a wavelength plate 56, an objective lens 57, a focus actuator 58 and a tracking actuator 59.

Here FIG. 7A is the case when data is recorded to/regenerated from the optical disk 1 with a 0.6 mm substrate, and FIG. 7B is the case when data is recorded to/regenerated from the optical disk 21 with a 1.2 mm substrate. In FIG. 7A, the light emitted from the laser detector integrated module 51 transmits through the optical beam splitter 53, becomes roughly parallel optical beams by the condensing lens 54, are then reflected by the mirror 55, transmitted through the wavelength plate 56 and the objective lens 57, and form an optical spot on the data recording layer of the optical disk 1. The optical beams reflected by the optical disk 1 return through the same routes, and are received by the photo-detector of the laser detector integrated module 51. The photo-detector detects the regeneration signals, and also detects the focus control signals and the tracking control signals. In FIG. 7B, the optical beam emitted from the laser detector integrated module 52 is reflected by the polarization beam splitter 53, becomes somewhat diverged optical beams by the condensing lens 54, reflected by the mirrors 55, transmitted through the wavelength plate 56 and the objective lens 57, and form an optical spot on the data recording layer of the optical disk 21. The optical beams reflected by the optical disk 21 return through the same route, and are received by the photo-detector of the laser detector integrated module 52.

The operation of the optical disk recording device 31 with the above description will now be described. This optical disk recording device 31 is constructed such that the data can be recorded in the data recording layer 5, 23 of the optical disk 1, 21, and visual information, such as image data, can be created on the thermal layer 11, 25. Now the operation of data recording and visual information creation will be described with reference to FIG. 8.

When the optical disk 1, 21 is set on the turntable 32 of the optical disk recording device 31 (step S1), the disk motor 33 is rotated by the disk motor driving circuit 34 based on an instruction from the controller 42. Then the photo-coupler 40 judges whether the FG pattern 9 or the reference pattern 10 is detected (step S2). If not detected, this means that the data recording layer 5, 23 is set so as to face the optical pickup 35. If detected, this means that the thermal layer 11, 25 of the optical disk 1, 21 is set so as to face the optical pickup 35. The above is the method of detecting which surface is facing the optical pickup 35 depending on whether the FG pattern 9 or the reference pattern 10 is detected, but the difference of the S character output value of the focus error signal may also be detected. In this way, according to the present embodiment, detecting the FG pattern 9 or the reference pattern 10, or by detecting the difference of the S character output value of the focus error signal, is used as a judgment means for judging the direction of the optical disk 1, 21.

If it is judged that the optical disk 1, 21 is set such that the data recording layer 5, 23 of the optical disk 1, 21 faces the optical pickup 35, the semiconductor laser of the optical pickup 35 is irradiated onto the optical disk at regeneration power, and judges whether the optical disk is the optical disk 1 or the optical disk 21 by the difference of the S character output value of the focus error signal (step S3). If the optical disk which is set is the optical disk 1, the optical pickup 35 is set on the optical path in FIG. 7A and is operated (step S4). If the optical disk which is set is the optical disk 21, the optical pickup 35 is set on the optical path in FIG. 7B and is operated (step S6). And based on the signal from the RF amplifier 36, the focus actuator 58 and the tracking actuator 59 are operated at the control drive current from the optical pickup driving circuit 37, and the optical spot is followed up onto a track of the data recording layer of the optical disk. Then the optical pickup transporting mechanism 39 is moved by driving the stepping motor 38, and the optical spot is followed up onto a predetermined track to be recorded. Based on the recording data to be supplied from the outside to the memory buffer 43 via the interface circuit 44, the controller 42 modulates the laser beam which is emitted from the optical pickup 35 by the laser driving circuit 41, and records the data information on the optical disk (steps S5, S7). The control method for recording the data information is the same as the conventional optical disk recording device, so a description of the detailed operation thereof is omitted.

If it is judged that the optical disk 1, 21 is set such that the thermal layer 11, 25 of the optical disk 1, 21 which is set faces the optical pickup 35, an FG signal from the photo-coupler 40, which detected the FG pattern 9, is input to the disk motor driving circuit 34, and the disk motor 33 is rotated at a predetermined angular speed. The reference signal from the photo-coupler 40, which detected the reference pattern 10, is input to the controller 42, and a timing signal for recording the visual information is generated.

The following description will be presented assuming that the optical disk 1 is set. The optical pickup 35 is set on the optical path for the 0.6 mm substrate shown in FIG. 7A by an instruction of the controller 42 (step S8), the focus actuator 58 is driven by the optical pickup driving circuit 37, and focus control is performed so that the optical spot is focused on the thermal layer 11 of the optical disk 1. In the optical disk 1, the disk clamp area surface 8 protrudes 0.2 mm from the thermal layer 11 of the protective substrate 3, so the thermal layer 11 is at the position 0.2 mm away from the turntable 32, as shown in FIG. 9B. This position is dimension d1=0.4 mm away from the position of the data recording layer 5 (see FIG. 9A) in the case when the optical disk 1 is set such that the data recording layer 5 faces the optical pickup 35, in order to record data on the optical disk 1. This 0.4 mm is a distance via a polycarbonate with a refractive index of about 1.55, so the optical distance is dimension d2=0.26 mm. Therefore the objective lens 57 must be offset by 0.26 mm higher compared with the position when the data is recorded. The movable range of the objective lens 57 of the focus actuator 58, however, is about 1.6 mm in the case of an optical disk recording device with half the height, and about 1.2 mm even in the case of a 12.7 mm high optical disk recording device, so this offset amount is within the performance range of an ordinary focus actuator 58. Conventionally, as a countermeasure when the offset amount exceeds the movable range of the focus actuator of the objective lens of the optical pickup, a configuration in which an adaptor with a predetermined thickness is inserted between the optical disk and the turntable, or a driving mechanism for separating the optical pickup from the turntable for a predetermined amount is used, but the present embodiment needs no such additional mechanism.

After focus control, the optical pickup transporting mechanism 39 is moved to a predetermined position by driving the stepping motor 38 (step S10). From this position, the controller 42 performs control for recording the visual information data, supplied from the outside to the memory buffer 43 via the interface circuit 44, on the optical disk 1 in step S9. In other words, the controller 42 generates a timing signal for recording the visual information from the reference signal from the photo-coupler 40 which detected the reference pattern 10, drives the laser driving circuit 41 based on the visual information data which was supplied to the memory buffer 43 at the timing of this timing signal, and pulse-modulates the laser beam which is output from the optical pickup 35. In the thermal layer 11, the micro-capsules dissolve and discolor by the peak power output of the pulse modulation, so the visual information of one cycle of the disk can be recorded on the thermal layer 11 by the pulse-modulated laser beam (step S11). Then the stepping motor 38 is driven for one step to move the optical pickup transporting mechanism 39 for a predetermined distance (step S12), one cycle of visual information is recorded by the above mentioned operation, and the visual information is completed on the thermal layer 11 (steps S13, S14). The operation in the case of recording the visual information on the disk 21 is the same as the above mentioned operation, so description thereof is omitted.

As described above, according to the optical disk 1, 21 of the present invention, the protruding section 7, 27 which protrudes from the surface at the thermal layer 11, 25 is created in the inner circumference area including the disk clamp area surface 8, 28 at the thermal layer 11, 25 side, which is the visual information recording layer, so that the optical distance from the end face of the protruding section 7, 27 to the thermal layer 11, 25 becomes closer to the optical distance from the surface at the transparent substrate 2, 22 side to the data recording layer 5, 23, so the optical distance between the position of the thermal layer 11, 25 in a status where the optical disk 1, 21 is set on the turntable 32 for recording the visual information and the position of the data recording layer 5, 23 in a status where the optical disk 1, 21 is set on the turntable 32 for recording the data information, can be closer than the case of a conventional optical disk, and as a result, the moving amount of the objective lens 57 of the optical pickup 35 installed on the optical disk recording device 31 for recording the data information and the visual information on the optical disk 1, 21 can be decreased. Therefore as mentioned above, the offset amount required for the optical disk recording device 31 can be within the performance range of the ordinary focus actuator 58, and the additional mechanism of prior art is unnecessary according to the optical disk recording device of the present embodiment, so the optical disk recording device 31 can be applied to all types of disk clamp systems and disk loading systems without restriction, and is particularly suitable for a slim type optical disk recording device of which the device height is about 12.7 mm or less.

In the present embodiment, the rotation of the disk motor 33 is controlled using the FG pattern 9 of the optical disk 1, 21, but the FG pattern of the optical disk need not be used if the disk motor comprises an FG.

In the present embodiment, an arrangement making the optical distance from the end face of the protruding section 7, 27 to the thermal layer 11, 25 become closer to the optical distance from the surface at the transparent substrate 2, 22 side to the data recording layer 5, 23 was described, but the present invention is not limited to this, but the optical distance from the end face of the protruding section to the thermal layer may become the same as the optical distance from the surface at the transparent substrate side to the data recording layer, and in this case as well, the user need not set an adapter at every usage, and operability improves compared with a conventional configuration of inserting an adapter with a predetermined thickness between the optical disk and the turntable. But in this case, the space of the disk clamp may be quite different, so some means of securing a predetermined clamp force is necessary for the case of a magnet clamp system.

In the optical disk and optical disk recording device according to the present invention, the focal point position of the thermal layer of the optical pickup to be used for recording the visual information is close to the focal point position of the recording layer, so it is unnecessary to add additional functions for recording visual information to an ordinary optical disk recording device. Therefore, the present invention is particularly useful for a slim type optical disk recording device of which device height is 12.7 mm or less.

1. An optical disk comprising:
a transparent substrate disposed on one surface of the disk;
a data recording layer for recording data inside of the transparent substrate by a laser beam irradiated through the transparent substrate; and
a visual information recording layer disposed on a disk surface opposite to the transparent substrate, for creating therein visual information by irradiating the laser beam, wherein
the optical disk further comprises a protruding section located in an inner circumference area including a disk clamp area surface at the visual information recording layer side, the protruding section protruding from the surface at the visual information recording layer so that an optical distance from the protruded end face to the visual information recording layer approximates to or equals to the optical distance from the transparent substrate outer surface to the data recording layer.

2. The optical disk according to claim 1, wherein the disk has a thickness of 1.2 mm at an area where the visual information recording layer is disposed and a thickness of not more than 1.4 mm at an area where the protruding section is disposed.

3. The optical disk according to claim 1, wherein an FG pattern for disk motor rotation synchronization and a reference pattern for disk position detection are created outside the disk clamp area and inside the area of the visual information recording layer, the FG pattern being optically detected.

4. The optical disk according to claim 3, wherein the protruding section comprises an optical disk having a thickness of 1.2 mm and a circular seal glued on the optical disk, the circular seal having the FG pattern and the reference pattern created thereon.

5. An optical disk recording device for recording visual information on the optical disk according to claim 1, comprising:
a disk motor having a turntable;
a disk motor driving circuit for controlling the rotation of the disk motor;
an optical pickup comprising optical elements including an objective lens for recording visual information;
a laser driving circuit for modulating a laser beam emitted from the optical pickup; and
an optical pickup transporting mechanism for moving the optical pickup in the radial direction of the optical disk, wherein
the optical disk is rotated in a status where the disk clamp area surface at the visual information recording layer of the optical disk is set on the turntable, and the laser beam modulated based on the visual information data of the optical pickup is focused on the visual information recording layer and irradiated, while moving the optical pickup in the radial direction, so that the visual information is created on the visual information recording layer.

6. The optical disk recording device according to claim 5, wherein the objective lens of the optical element is constructed so as to suit the transparent substrate that is thinner than 1.2 mm.

7. The optical disk recording device according to claim 5, wherein an FG pattern for disk motor rotation synchronization that can be optically detected and a reference pattern for disk position detection are created on the visual information recording layer of the optical disk, a photo-coupler for detecting the FG pattern and the reference pattern is disposed on the optical disk recording device, a signal from the FG pattern detected by the photo-coupler is input to the disk motor driving circuit to control the rotation of the disk motor, and a signal from the reference pattern is input to the laser driving circuit to irradiate the laser beam according to the disk rotation position.

8. The optical disk recording device according to claim 5, wherein the optical pickup further comprises an optical element including an objective lens suitable for a 0.6 mm substrate, and the optical element is used for the optical pickup for creating the visual information.

9. The optical disk recording device according to claim 5, wherein the optical pickup comprises an optical system for a CD disk and an optical system for a DVD disk, and the optical system for a DVD disk is used for the optical pickup for creating the visual information.
